(19) United States
(12) Patent Application Publication
(10) Pub. No.: US 2006/0124880 A1
(43) Pub. Date: Jun. 15, 2006

(54) Magnetically-actuated manually-operated isolation valve

(75) Inventor: Paul T. King, Williamsville, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Moog Inc.

(21) Appl. No.: 11/012,027

(22) Filed: Dec. 14, 2004

(51) Int. Cl. F16K 31/08

(52) U.S. Cl. 251/65

(57) ABSTRACT

A magnetically-actuated manually-operated valve (20) includes a body (21) having a flow passage (28, 35) with a seat (31) surrounding an intermediate portion thereof; an armature (22) mounted on the body for movement toward and away from the seat; the seal member (23) carried by the armature; a shorting member (24) adapted to be selectively mounted on the body in at least one position; and a magnet (25) mounted on one of the body and shorting member. The body, magnet and shorting member are so configured and arranged such that when the shorting member is removed from the body, the magnet flux will follow a first flux path (52) through the body and armature to cause the armature to move to a first position relative to the seat. However, when the shorting member is mounted on the body in the one position, the magnet flux will follow a second flux path (55) through the body and shorting member to cause the armature to move to a second position relative to the seat.

### TECHNICAL FIELD

The present invention relates generally to the fields of valves and switches, and, more particularly, to an improved magnetically-actuated manually-operated isolation valve.

### BACKGROUND ART

It is sometimes necessary to isolate one fluid from another for a long period of time. During this lengthy period, the isolation valve should have a high degree of sealing integrity, and yet be readily movable to an alternative position to allow the isolated fluid to flow through the valve. At the same time, it would be highly desirable to provide such a valve that does not require that external energy be supplied from a tethered source.

To this end, others have developed magnetically-actuated valves. Examples of these are shown and described in U.S. Pat. Nos. 2,289,574, 3,570,806, 4,327,892, 4,561,632, 4,671,486, 4,794,890, 4,883,025, 5,611,368, 6,000,417, 6,068,010 and 6,691,740. The aggregate disclosures of these prior art patents is hereby incorporated by reference with respect to the structure and operation of such prior art magnetically-actuated valve designs.

### DISCLOSURE OF THE INVENTION

With parenthetical reference to the corresponding parts, portions or surfaces of the disclosed embodiments, merely for purposes of illustration and not by way of limitation, the present invention provides an improved magnetically-actuated manually-operated isolation valve.

In one aspect, the invention provides a valve (20) that broadly comprises: abody (21) having a flow passage (28, 35) therethrough extending between an inlet (29) and an outlet (30), the body having a seat (32) surrounding an intermediate portion of the flow passageway; an armature (22) mounted on the body for movement toward and away from the seat; a seal member (23) carried by the armature, the seal member being adapted to be moved toward the seat and to engage the seat to close the passageway, and adapted to be moved away from the seat to open the passageway; a shorting member (24) adapted to be selectively mounted on the body in at least one position; and a magnet (25) mounted on one of the body and shorting member; the body, magnet and shorting member being so configured and arranged such when the shorting member is not mounted on the body in the one position the magnet flux will follow a first flux path (52) through the body and armature to cause the armature to move to a first position (i.e., as shown in FIG. 3) relative to the seat, but when the shorting member is mounted on the body in the one position (i.e., as shown in FIG. 4) the magnet flux will follow a second flux path (55) through the body and shorting member to cause the armature to move to a second position (i.e., as shown in FIG. 4) relative to the seat; whereby the armature will be in the first position when the shorting member is not mounted on the body in the one position, and in the second position when the shorting member is mounted on the body in the one position.

In a preferred form, at least one spring (48, 49) is arranged to act between the body and armature for urging the armature to move in one direction (e.g., toward) relative to the seat. The spring may be an S-spring, or may be some other type of spring, such as a coil spring, a Belleville spring, a leaf spring, and so on. The spring need not be sealingly mounted to either the body or the armature.

The improved valve may further include one or more fluids in the passageway. As used herein, the word “fluid” is generic to either a liquid or a gas. The passageway may be filled with a wide range of gaseous fluids, such as xenon, argon, helium, nitrogen, air, etc., and/or a wide range of liquid fluids, such as water, alcohol, hydrazine, etc., or mixtures of various gases and liquids.

The shorting member (24) may be adapted to be manually mounted on, and removed from, the body. A fastener (46) may be used to selectively hold the shorting member on the body.

The magnet may be radially polarized. The first flux path may include a constant-reluctance air gap (53) and a variable-reluctance air gap (54). However, the second flux path may not include an air gap.

The body may have a fluid section communicating with the passageway, and a dry section.

The armature may be arranged in the fluid section. In one particular form, the valve is open when the magnet flux follows the first flux path, and closed when the magnet flux follows the second flux path. The magnet may include a first magnet (65) mounted on the body and/or a second magnet (71) mounted on the shorting member.

In another aspect, the invention provides a two-position switch which broadly includes: a body (21); an armature (22) mounted on the body for movement toward and away from a portion on the body; a shorting member (24) adapted to be selectively mounted on the body in one position; a magnet (25) mounted on one of the body and shorting member; the body, magnet and shorting member being so configured and arranged such when the shorting member is not mounted on the body in the one position the magnet flux will follow a first flux path (52) through the body and armature to cause the armature to move to a first position relative to the seat, but when the shorting member is mounted on the body in the one position the magnet flux will follow a second flux path (55) through the body and shorting member to cause the armature to move to a second position relative to the seat; whereby the armature will be in the first position when the shorting member is not mounted on the body in the one position, and in the second position when the shorting member is mounted on the body in the one position.

The magnet may include a first magnet mounted on the body and/or a second magnet mounted on the shorting member.

Accordingly, the general object of the invention is to provide a valve.

Another object is to provide a switch.

Still another object is to provide a manually-operated magnetically-actuated two-position isolation valve.

These and other objects and advantages will become apparent from the foregoing and ongoing written specification, the drawings and the appended claims.

### BRIEF DESCRIPTION OF THE DRAWINGS

FIG. 1 is a fragmentary vertical sectional view of a first form of an improved magnetically-actuated manually-operated isolation valve, this view showing the shorting member and fastener in exploded relation to the valve body.

FIG. 2 is an enlarged isomeric view looking at the underside of the armature and spring.

FIG. 3 is a fragmentary vertical sectional view thereof, generally similar to FIG. 1, showing the first magnet flux path when the shorting member is removed.

FIG. 4 is a view similar to FIG. 3, but showing the alternative second magnet flux path when the shorting member is mounted on the body.

FIG. 5 is a fragmentary vertical sectional view of a second form of improved valve, this embodiment showing a first magnet mounted on the body, and a second magnet mounted on the shorting member, and showing the first flux path when the shorting member is removed from the body.

FIG. 6 is a fragmentary vertical sectional view similar to FIG. 5, but showing the second flux path when the shorting member is mounted on the body.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement ofparts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

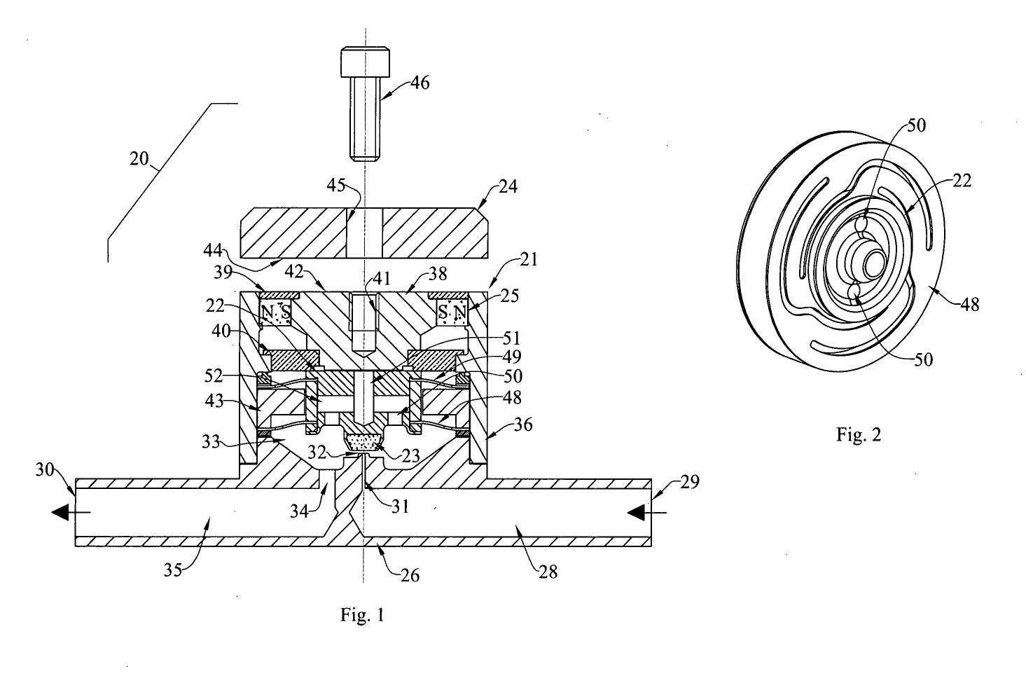

### First Embodiment (FIGS. 1-4)

Referring now to the drawings, and, more particularly, to FIGS. 1 and 2 thereof, a first form of an improved magnetically-actuated manually-operated isolation valve is generally indicated at 20. Valve 20 is shown as having an assembled body, generally indicated at 21; an armature 22; a seal member 23 carried by the armature; a shorting member 24; and a magnet 25 mounted on the body.

The assembled body 21 is shown as including a lower core part 26 containing a fluid flow passageway 28 that extends between an inlet 29 and an outlet 30. The lower core part also includes an orifice-like passageway 31 that extends upwardly from an intermediate part of the fluid flow passageway and is surrounded by an annular seat 32. Thus, fluid may flow from the inlet through inlet passageway 28, up through orifice-like passageway 31 and around and about the seat to enter a chamber 33. Chamber 33 communicates via passageway 34 with an outlet passageway 35 that extends to the outlet.

The body also includes an upstanding outer cylindrical wall 36, and an upper intermediate part 38. The lower marginal end portion of body part 36 is received and suitably secured, as by welding, to the body core part 26.

The body intermediate part 38 is shown as being a vertically-elongated specially-configured member, and is mounted on the upper marginal end portion of body part 36 via an intermediate radially-polarized ring magnet 25, an upper isolation member 39, and a lower annular isolation member 40. Isolation members 39,40 are both annular or ring-like members, but are formed of a material that is not conductive of magnetic flux. Hence, from a magnetic point-of-view, these isolation members 39, 40 have a high reluctance, and are, for all intents and purposes, practically the same reluctance as an air gap. The lower isolation member 40 may be suitably secured, again as by welding or the like, to body outer part 36 and a body intermediate part 38. A tapped blind hole 41 extends axially downwardly into body intermediate part 38 from its upper planar surface 42. The body outer and intermediate parts 36, 38 are formed of a flux-conductive material. The body lower core part 26 may also be formed of this material, or may be formed of some other material. An annular polepiece, indicated at 43, is mounted on the inside wall of body part 36 and has its inwardly-facing cylindrical surface arranged to face the outer peripheral surface of the armature.

The shorting member 24 is shown as being a disk- or plate-like member having a lower horizontal planar surface 44 that is arranged to abut body upper surface 42 in large area contact. The shorting member has an axial through-hole 45 to accommodate passage of the threaded shank portion of a suitable fastener 46, by means of which the shorting member 24 may be removably mounted in a first position on the body. This first position is shown more completely in FIG. 4.

Adverting now to FIGS. 1 and 2, the armature is shown as being a specially-configured member having a lowermost recess portion filled with a suitable seat seal material 23, such as Vespel® (a synthetic resinous plastic material available form E. I. du Pont de Nemours & Co., 1007 Market Street, Wilmington, Del. 19898), or the like. The armature is mounted on the body by springs 48, 49, for vertical movement relative to the body and toward and away from seat 32. In the illustrated form, the springs are S-springs, as more fully shown in FIG. 4. Note that the armature has openings 50, 51 that communicate the lower and upper surfaces of same with an internal transverse passageway 52. Thus, fluid in chamber 33 may pass through these communicating passageways, and will exist all around the armature. Otherwise stated, chamber 33 is filled with the serviced fluid, and the armature is mounted in fluid-filled chamber 33 for selective controlled movement toward and away from the seat. In the illustrated form, since the armature is surrounded by the serviced fluid, the inner and outer marginal end portions of springs 48, 49 are simply mounted on the armature and body, respectively. However, they need not be sealingly mounted to either structure. In another alternative design, the S-springs could be replaced by Belleville springs, or the armature might be biased by a coil or leaf spring as desired. In these alternative forms, the springs might possibly be sealingly mounted to the body and the armature.

In the preferred embodiment, the magnet is an annular ring-like magnet that is mounted on the body and that is polarized in a.radial direction. However, it is possible that the magnet could be located in other positions, and appropriate polepieces could be used to direct the flux.

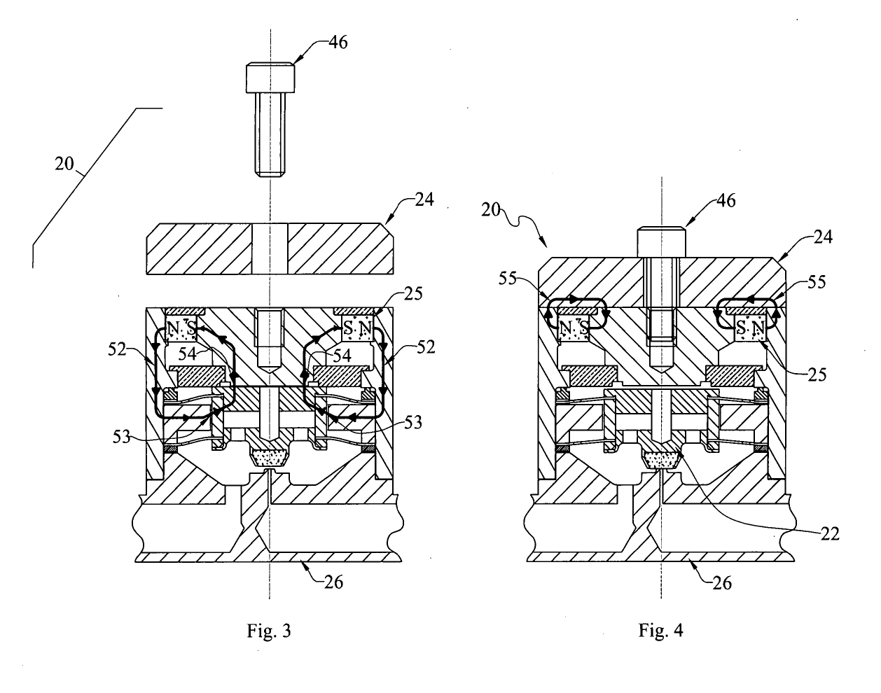

FIGS. 3 and 4 illustrate the first and second flux paths for the magnet flux depending on whether the shorting member is mounted in the first position on the body or not.

In FIG. 3, the shorting member is depicted as being separated from the body. Hence, flux, which for purposes of illustration is assumed to flow from the North pole to the South pole, issues from the North pole of the magnet and follows a first flux path generally indicated at 52. This first flux path then includes the body outer part 36, polepiece 43, a fixed air gap 53 between the polepiece and the armature, the armature itself, a variable-reluctance air gap 54 between the armature upper face and the lower planar horizontal surface of body intermediate part 38, and then through the body intermediate part to the South pole. Air gap 53 is a substantially fixed-length constant-reluctance non-working air gap. However, air gap 54 is a variable-length variable-reluctance working air gap. The reluctance of this air gap varies with the length of the air gap. Thus, when the shorting member is removed, the magnet flux follows the first flux path, and pulls the armature upwardly against the lower surface of body intermediate part 38.

FIG. 4 illustrates an alternative embodiment when the shorting member 24 is mounted on the body in the first position. The shorting member is also flux conductive. Hence, when the shorting member is mounted on the body, the flux follows an alternative second flux path, indicated at 55. According to this flux path, flux issuing from the North pole flows upwardly through body part 36 then through the shorting member, and then through the body intermediate part 38 to return to the South pole. Since the second flux passageway does not include any air gaps, the springs may expand to urge the armature to move downwardly into fluid-tight sealing engagement with the seal member engaging the seat. This arrangement shows fluid flow through the passageway thereafter being blocked.

Thus, in FIG. 3, the first flux passageway includes a constant-reluctance fixed-length air gap 53, and a variable-reluctance variable-length air gap 54in series with one another. However, in the alternative second flux passage shown in FIG. 4, the alternative flux pathway does not include any air gap. Hence, when the shorting member is mounted on the body, the second flux path is the path of least resistance.

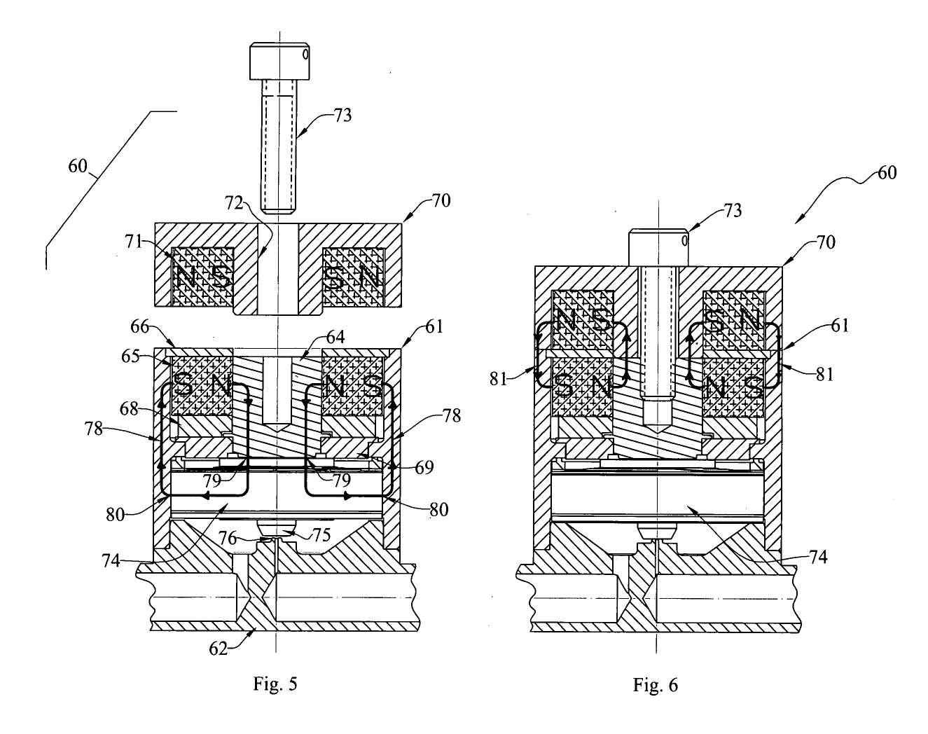

### Second Embodiment (FIGS. 5-6)

FIGS. 5 and 6 illustrate a second form of the improved valve. In this form, the valve is generally indicated at 60. The valve specifically includes an assembled body 61, which includes a body lower core part 62, a body outer part 63 and a body intermediate part 64. A radially-polarized ring magnet 65 is mounted on the assembled body, and is sandwiched between an upper isolation disc 66, and two lower isolation disks 68, 69. Whereas body part 62, 63 and 64 are flux conductive, isolation disks 66, 68 and 69 are not flux conductive, and act substantially as an air gap.

In the second form, the shorting member 70 includes an annular ring-like magnet 71. The shorting member is also shown as having a vertical through-hole 72 to accommodate passage of the threaded shank portion of a headed fastener 73 by means of which the shorting member may be removably mounted in a first position on the body. This first position is shown in FIG. 6. This arrangement also includes a spring-biased armature, collectively indicated at 74 that is movable upwardly and downwardly such that a seal 75 carried on the under set of the armature maybe controllably moved toward and away from a seat 76 on the body lower core part.

When the shorting member is removed from the body, the magnet flux follows a first pathway, indicated at 78. More particularly, the flux is seen as flowing from the North pole downwardly through the body intermediate part 74, through a variable-reluctance variable-length air gap 79, through the armature, across a radial constant-length constant-reluctance air gap 80, and then up through the body outer part 63 to return to the South pole. Thus, when the shorting member is removed, the magnet exerts a tractive force that pulls the armature upwardly relative to the assembled body.

When the shorting member is mounted on the body in the first position, as shown in FIG. 6, then the flux will immediately follow an alternative second path, indicated at 81. Here, flux flows from the North pole of the body-mounted magnet to the proximate South pole of the shorting member-mounted magnet, effectively removing the tractive force on the armature. Hence, the springs may expand, and may urge the armature to move downwardly relative to the body to sealingly engage the seat.

Therefore, in one aspect, the invention broadly provides an improved valve and switch.

In one aspect, the invention provides a valve (20) that comprises: a body (21) having a flow passage (28,35) therethrough extending between an inlet (29) and an outlet (30), the body having a seat (32) surrounding an intermediate portion of the flow passageway; an armature (22) mounted on the body for movement toward and away from the seat; a seal member (23)carried by the armature, the seal member being adapted to be moved toward the seat and to engage the seat to close the passageway, and adapted to be moved away from the seat to open the passageway; a shorting member (24) adapted to be selectively mounted on the body in one position; and a magnet (25) mounted on one of the body and shorting member; the body, magnet and shorting member being so configured and arranged such when the shorting member is not mounted on the body in the one position the magnet flux will follow a first flux path (52) through the body and armature to cause the armature to move to a first position relative to the seat, but when the shorting member is mounted on the body in the one position the magnet flux will follow a second flux path (55) through the body and shorting member to cause the armature to move to a second position relative to the seat; whereby the armature will be in the first position when the shorting member is not mounted on the body in the one position, and in the second position when the shorting member is mounted on the body in the one position.

In another aspect, the invention provides a switch (20) which broadly includes: a body (23); an armature (22) mounted on the body for movement toward and away relative thereto; a shorting member (24) adapted to be selectively mounted on the body in one position; a magnet (25) mounted on one of the body and shorting member; the body, magnet and shorting member being so configured and arranged such when the shorting member is not mounted on the body in the one position the magnet flux will follow a first flux path (52) through the body and armature to cause the armature to move to a first position relative to the seat, but when the shorting member is mounted on the body in the one position the magnet flux will follow a second flux path (55) through the body and shorting member to cause the armature to move to a second position relative to the seat; whereby the armature will be in the first position when the shorting member is not mounted on the body in the one position, and in the second position when the shorting member is mounted on the body in the one position.

Modifications

The present invention expressly contemplates that many changes and modifications may be made. For example, the body may be an assembly of different parts. Each of the various body component parts may have different shapes and forms. As indicated, those portions of the body that are needed to permit flux to flow through the first passageway 52 should be magnetically conductive. The other body parts may be magnetically conductive as well.

The shorting member may be formed of a flux-conductive material, such as iron, and/or may have its own magnet that is designed to interrelate with the magnet on the body. Indeed, in still another form, the body magnet could be eliminated, and the magnet could be provided solely on the shorting member. As used in the appended claims the reference to “one position” refers to the illustrated positions of the shorting member on the body. However, it is contemplated that the shorting member could possibly, in other embodiments, be mounted at alternative positions on the body. As indicated above, the serviced fluid, in the case of a valve, may be virtually any compatible liquid and/or gas. However, the invention also may be visualized as being a two-position switch as well.

Therefore, while two forms of the improved valve and switch have been shown and described, and several modifications thereof discussed, persons skilled in this art will readily appreciate that various additional changes and modifications may be made without departing from the spirit of the invention, as defined and differentiated by the following claims.

What is claimed is:

1. A valve, comprising:
a body having a flow passage therethrough extending between an inlet and an outlet, said body having a seat surrounding an intermediate portion of said flow passageway;
an armature mounted on said body for movement toward and away from said seat;
a seal member carried by said armature, said seal member being adapted to be moved toward said seat and to engage said seat to close said passageway, and adapted to be moved away from said seat to open said passageway;
a shorting member adapted to be selectively mounted on said body in one position; and
a magnet mounted on one of said body and shorting member;
said body, magnet and shorting member being so configured and arranged such when said shorting member is not mounted on said body in said one position the magnet flux will follow a first flux path through said body and armature to cause said armature to move to a first position relative to said seat, but when said shorting member is mounted on said body in said one position said magnet flux will follow a second flux path through said body and shorting member to cause said armature to move to a second position relative to said seat;
whereby said armature will be in said first position when said shorting member is not mounted on said body in said one position, and in said second position when said shorting member is mounted on said body in said one position.

2. A valve as set forth in claim 1 and further comprising at least one spring acting between said body and armature for urging said armature to move in one direction relative to said seat.

3. A valve as set forth in claim 2 wherein said spring urges said armature to move toward said seat.

4. A valve as set forth in claim 2 wherein said spring is an S-spring.

5. A valve as set forth in claim 2 wherein said spring is not sealingly mounted to at least one of said body and armature.

6. A valve as set forth in claim 1, and further comprising fluid in said passageway.

7. A valve as set forth in claim 6 wherein said fluid contains xenon.

8. A valve as set forth in claim 1 wherein said shorting member is adapted to be manually mounted on, and removed from, said body.

9. A valve as set forth in claim 8, and further comprising a fastener for selectively holding said shorting member on said body.

10. A valve as set forth in claim 1 wherein said magnet is radially polarized.

11. A valve as set forth in claim 1 wherein said first flux path includes a constant-reluctance air gap and a variable-reluctance air gap.

12. A valve as set forth in claim 1 where in said second flux path does not include an air gap.

13. A valve as set forth in claim lwherein said body has a fluid section communicating with said passageway, and a dry section.

14. A valve as set forth in claim 13 wherein said armature is arranged in said fluid section.

15. A valve as set forth in claim 1 wherein said valve is open when said magnet flux follows said first flux path, and closed when said magnet flux follows said second flux path.

16. A valve as set forth in claim 1 wherein a first magnet is mounted on said body.

17. A valve as set forth in claim 16 wherein a second magnet is mounted on said shorting member.

18. A switch, comprising:
a body;
an armature mounted on said body for movement toward and away relative there-to;
a shorting member adapted to be selectively mounted on said body in one position;
a magnet mounted on one of said body and shorting member;
said body, magnet and shorting member being so configured and arranged such when said shorting member is not mounted on said body in said one position the magnet flux will follow a first flux path through said body and armature to cause said armature to move to a first position relative to said seat, but when said shorting member is mounted on said body in said one position said magnet flux will follow a second flux path through said body and shorting member to cause said armature to move to a second position relative to said seat;
whereby said armature will be in said first position when said shorting member is not mounted on said body in said one position, and in said second position when said shorting member is mounted on said body in said one position.

19. A switch as set forth in claim 18 wherein a first magnet is mounted on said body.

20. A switch as set forth in claim 19 wherein a second magnet is mounted on said shorting member.
